(19) United States
(12) Patent Application Publication
(10) Pub. No.: US 2026/0264718 A1
(43) Pub. Date: Sep. 10, 2026

(54) DRIVING ASSISTANCE SYSTEM, STORAGE MEDIUM STORING DRIVING ASSISTANCE PROGRAM, AND DRIVING ASSISTANCE METHOD

(71) Applicant: J-QuAD DYNAMICS Inc., Tokyo (JP)

(72) Inventors: Manabu NAGASAKA, Tokyo (JP); Masaki SHIOTA, Tokyo (JP); Takuto KOZAKI, Tokyo (JP); Toyohito NOZAWA, Tokyo (JP)

(21) Appl. No.: 19/660,734

(22) Filed: Apr. 28, 2026

Related U.S. Application Data
(63) Continuation of application No. PCT/JP2024/033146, filed on Sep. 17, 2024.

(30) Foreign Application Priority Data
Nov. 7, 2023 (JP) 2023-190330

(51) Int. Cl. B60W 60/00; B60W 10/184; B60W 10/20

(52) U.S. Cl. CPC B60W 60/0017; B60W 10/184; B60W 10/20; B60W 2520/06; B60W 2710/18; B60W 2710/20; B60W 2720/14

(57) ABSTRACT

A driving assistance system which is configured to assist in collision avoidance between a host vehicle and an object during operation of the host vehicle includes a processor. The processor is configured to: determine a driving trajectory during an avoidance control period; and control a steering angle and a braking force according to the driving trajectory. The determination of the driving trajectory includes selecting, from among a single control mode and a coordinated control mode, a control mode that matches the response characteristics estimated for the host vehicle; determining the driving trajectory so as to specify a required yaw rate.

### CROSS REFERENCE TO RELATED APPLICATION

The present application is a continuation application of International Patent Application No. PCT/JP2024/033146 filed on September 17, 2024 which designated the U.S. and claims the benefit of priority from Japanese Patent Application No. 2023-190330 filed on November 7, 2023. The entire disclosures of all of the above applications are incorporated herein by reference.

### TECHNICAL FIELD

The present disclosure relates to a driving assistance technology that assists in avoiding collisions with an object during the driving of a vehicle.

### BACKGROUND

The technology disclosed in a related art controls steering torque for avoiding a collision with an object in a vehicle.

### SUMMARY

According to an aspect of the present disclosure, a driving assistance system includes a processor. The driving assistance system is configured to assist in a collision avoidance between a host vehicle and an object during operation of the host vehicle. The processor may be configured to: determine a driving trajectory of the host vehicle during an avoidance control period in which the host vehicle is controlled for the collision avoidance; and control a steering angle and a braking force applied to wheels of the host vehicle according to the driving trajectory, respectively. The determination of the driving trajectory may include: selecting, from among a single control mode in which a turning posture of the host vehicle during the avoidance control period is controlled by a single adjustment of the steering angle and a coordinated control mode in which the turning posture during the avoidance control period is controlled by a coordination of the steering angle and the braking force, a control mode that matches a response characteristic estimated for the host vehicle during the avoidance control period; determining the driving trajectory so as to specify a required yaw rate necessary to control the turning posture by the single adjustment of the steering angle in the single control mode; and determining the driving trajectory so as to specify the required yaw rate necessary to control the turning posture by the coordination of the steering angle and the braking force in the coordinated control mode.

### BRIEF DESCRIPTION OF DRAWINGS

Objects, features and advantages of the present disclosure will become more apparent from the following detailed description made with reference to the accompanying drawings. In the drawings:

FIG. 1 is a block diagram showing a physical configuration of a driving assistance system according to a first embodiment;

FIG. 2 is a schematic diagram showing a driving environment of a host vehicle to which the first embodiment is applied;

FIG. 3 is a block diagram showing a functional configuration of the driving assistance system according to the first embodiment;

FIG. 4 is a flowchart showing a driving assistance flow according to the first embodiment;

FIG. 5 is a graph for explaining the driving assistance flow according to the first embodiment;

FIG. 6 is a graph for explaining the driving assistance flow according to the first embodiment;

FIG. 7 is a schematic diagram for explaining the driving assistance flow according to the first embodiment;

FIG. 8 is a flowchart showing a driving assistance flow according to a second embodiment;

FIG. 9 is a flowchart showing an arbitration subroutine according to the second embodiment;

FIG. 10 is a graph for explaining the arbitration subroutine according to the second embodiment; and

FIG. 11 is a graph for explaining the arbitration subroutine according to the second embodiment.

### DETAILED DESCRIPTION

In the technology disclosed in a related art, even during deceleration of the vehicle due to braking, a target steering angle is merely set based on the predicted amount of lateral movement required along the travel trajectory to avoid a collision. As a result, when control is limited to adjusting the steering torque to achieve the target steering angle according to the required lateral movement, there is a concern that, depending on the driving environment and the overall responsiveness limits of the vehicle, collision avoidance may be compromised.

The present disclosure provides a driving assistance system effective for avoiding collisions with objects in a vehicle. Another object of the present disclosure is to provide a driving assistance program effective for avoiding collisions with objects in a vehicle. Still another object of the present disclosure is to provide a driving assistance method effective for avoiding collisions with objects in a vehicle.

According to one aspect of the present disclosure, a driving assistance system includes a processor. The driving assistance system is configured to assist in a collision avoidance between a host vehicle and an object during operation of the host vehicle. The processor is configured to: determine a driving trajectory of the host vehicle during an avoidance control period in which the host vehicle is controlled for the collision avoidance; and respectively control a steering angle and a braking force applied to wheels of the host vehicle according to the driving trajectory. The determination of the driving trajectory includes: selecting, from among a single control mode in which a turning posture of the host vehicle during the avoidance control period is controlled by a single adjustment of the steering angle and a coordinated control mode in which the turning posture during the avoidance control period is controlled by a coordination of the steering angle and the braking force, a control mode that matches a response characteristic estimated for the host vehicle during the avoidance control period; determining the driving trajectory so as to specify a required yaw rate necessary to control the turning posture by the single adjustment of the steering angle in the single control mode; and determining the driving trajectory so as to specify the required yaw rate necessary to control the turning posture by the coordination of the steering angle and the braking force in the coordinated control mode.

According to one aspect of the present disclosure, a non-transitory computer readable storage medium stores a driving assistance program stored in a storage medium for assisting a collision avoidance between a host vehicle and an object during operation of the host vehicle. The driving assistance program includes instructions for causing a processor to: determine a driving trajectory of the host vehicle during an avoidance control period in which the host vehicle is controlled for the collision avoidance; and respectively control a steering angle and a braking force applied to wheels of the host vehicle according to the driving trajectory. The determination of the driving trajectory includes: selecting, from among a single control mode in which a turning posture of the host vehicle during the avoidance control period is controlled by a single adjustment of the steering angle, and a coordinated control mode in which the turning posture during the avoidance control period is controlled by a coordination of the steering angle and the braking force, a control mode that matches a response characteristic estimated for the host vehicle during the avoidance control period; determining the driving trajectory so as to specify a required yaw rate necessary to control the turning posture by the single adjustment of the steering angle in the single control mode; and determining the driving trajectory so as to specify the required yaw rate necessary to control the turning posture by the coordination of the steering angle and the braking force in the coordinated control mode.

According to one aspect of the present disclosure, a driving assistance method is executed by a processor for assisting a collision avoidance between a host vehicle and an object during operation of the host vehicle. The driving assistance method includes: determining a driving trajectory of the host vehicle during an avoidance control period in which the host vehicle is controlled for the collision avoidance; and respectively controlling a steering angle and a braking force applied to wheels of the host vehicle according to the driving trajectory. The determination of the driving trajectory includes: selecting, from among a single control mode in which a turning posture of the host vehicle during the avoidance control period is controlled by a single adjustment of the steering angle, and a coordinated control mode in which the turning posture during the avoidance control period is controlled by a coordination of the steering angle and the braking force, a control mode that matches a response characteristic estimated for the host vehicle during the avoidance control period; determining the driving trajectory so as to specify a required yaw rate necessary to control the turning posture by the single adjustment of the steering angle in the single control mode; and determining the driving trajectory so as to specify the required yaw rate necessary to control the turning posture by the coordination of the steering angle and the braking force in the coordinated control mode.

In these aspects, during the avoidance control period for controlling the host vehicle toward collision avoidance with an object, the steering angle and the braking force applied to the wheels in the host vehicle are each controlled according to the driving trajectory of the host vehicle. Therefore, in the avoidance control period of the first to third aspects, the driving trajectory of the host vehicle is determined so as to define the required yaw rate.

Specifically, in the determination of the driving trajectory according to the first to third aspects, a control mode that matches the response characteristics estimated for the host vehicle in the avoidance control period is selected. As a result, in a driving environment where the turning posture of the host vehicle toward collision avoidance can be controlled even by the single adjustment of the steering angle, the single control mode matching the estimated response characteristics in the avoidance control period is selected, and the required yaw rate for controlling the turning posture by the single adjustment can be reflected in the driving trajectory. On the other hand, in a driving environment where control of the turning posture toward collision avoidance is required in a short time by the coordination of the steering angle and the braking force, the coordinated control mode matching the estimated response characteristics in the avoidance control period is selected, and the required yaw rate for controlling the turning posture by the coordination can be reflected in the driving trajectory. According to the above configuration, it becomes possible to provide driving assistance to the host vehicle according to a driving trajectory that is effective regardless of the driving environment in collision avoidance with an object.

Hereinafter, a plurality of embodiments of the present disclosure will be described based on the drawings. In each embodiment, corresponding constituent elements may be denoted by the same reference numerals, and redundant description may be omitted. In addition, when only a part of the configuration is described in each embodiment, the configuration of other embodiments described previously can be applied to other parts of the configuration. Furthermore, not only the combinations of configurations explicitly stated in the description of each embodiment, but also configurations of a plurality of embodiments can be partially combined provided that there is no hindrance in the combination in particular.

### First Embodiment

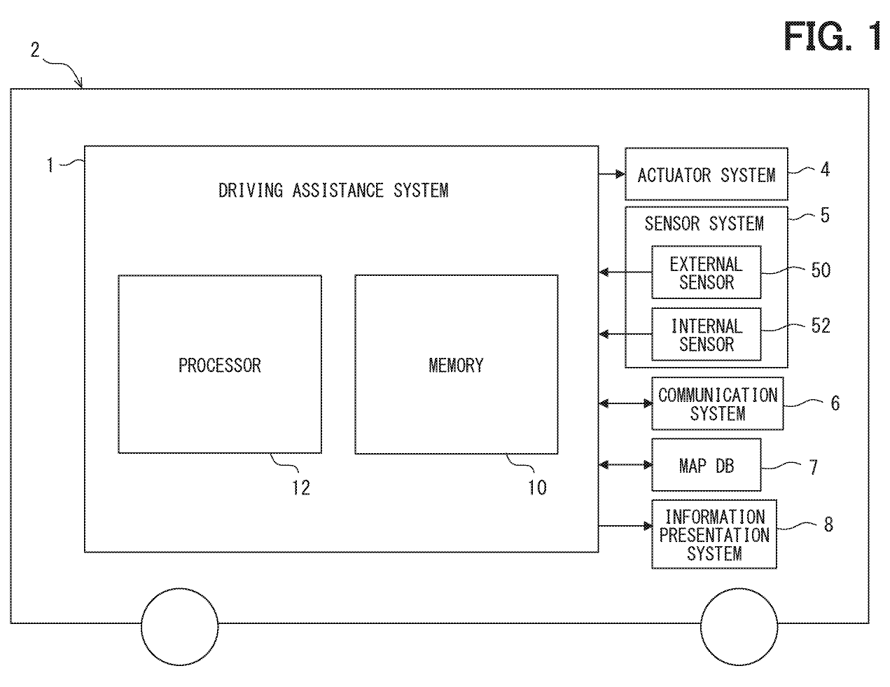

A driving assistance system 1 of a first embodiment shown in FIG. 1 assists driving of a host vehicle 2. At least a part of the driving assistance system 1 is mounted on the host vehicle 2. The host vehicle 2 to which the driving assistance system 1 is applied is preferably capable of realizing, for example, a level among automated driving levels defined in SAE (Society of Automotive Engineers) J3016 etc., where a manual driving assistance task for assisting a manual driving operation of an operator exists together with an automated driving task. Such a host vehicle 2 is, for example, a road user such as an automobile or a truck. The host vehicle 2 may be referred to as an ego-vehicle. The driving assistance system 1 targets a driver who is on board the host vehicle 2 and capable of performing manual driving operations as an operator of the host vehicle 2, for driving assistance.

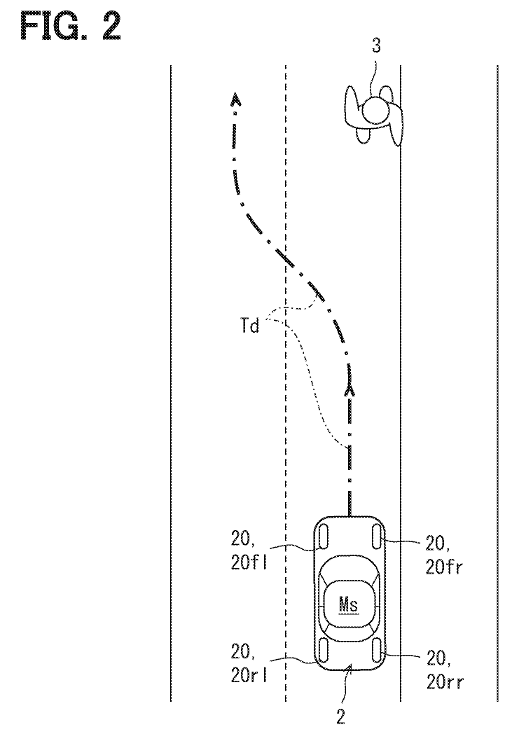

As shown in FIG. 2, in a driving environment where the host vehicle 2 travels, at least one type among, for example, other road users, obstacles, structures, etc., exists as an object 3 other than the host vehicle 2. Other road users include non-vulnerable road users and vulnerable road users. Non-vulnerable road users are at least one type of mobile object on which a human rides, such as automobiles, trucks, motorcycles, and bicycles. Vulnerable users are, for example, pedestrians and the like. Obstacles include at least one type among, for example, construction signs, work signs, fallen objects, and the like. Structures include at least one type among, for example, buildings, road structures, traffic lights, road signs, and the like.

As shown in FIG. 1, an actuator system 4, a sensor system 5, a communication system 6, a map database (data base: DB) 7, and an information presentation system 8 are mounted on the host vehicle 2 together with at least a part of the driving assistance system 1. However, FIG. 1 representatively shows an example in which the entirety of the driving assistance system 1 implemented in the form of a processing circuit (e.g., processing ECU, etc.) or a semiconductor device (e.g., semiconductor chip, etc.) is mounted on the host vehicle 2.

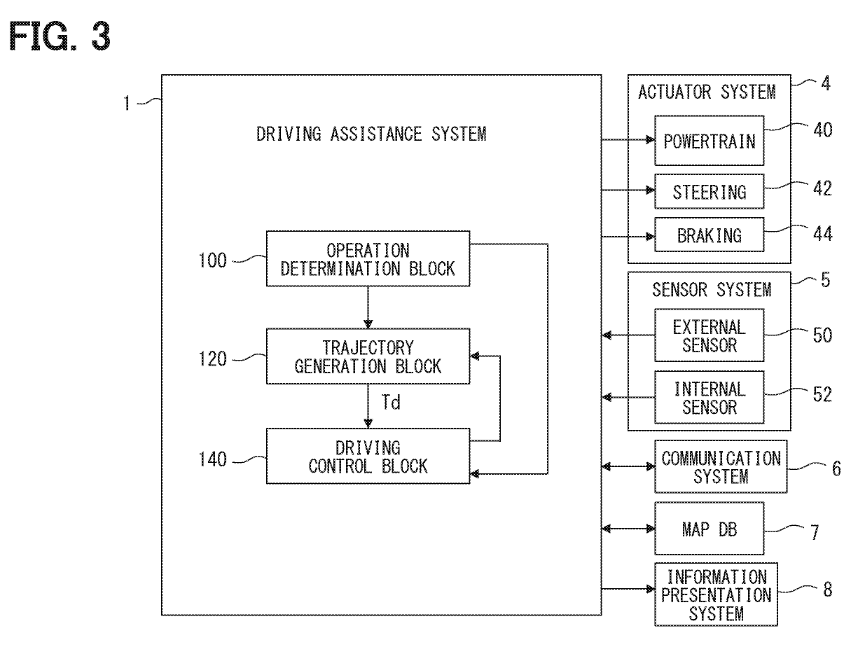

The actuator system 4 is configured to be capable of controlling the driving behavior of the host vehicle 2 based on control commands from the driving assistance system 1. As shown in FIG. 3, the actuator system 4 includes at least one type of powertrain actuator 40 among, for example, an internal combustion engine, a motor generator, and the like. The actuator system 4 includes at least one type of steering actuator 42, such as a power steering unit. The actuator system 4 includes at least one type of braking actuator 44, such as a brake unit.

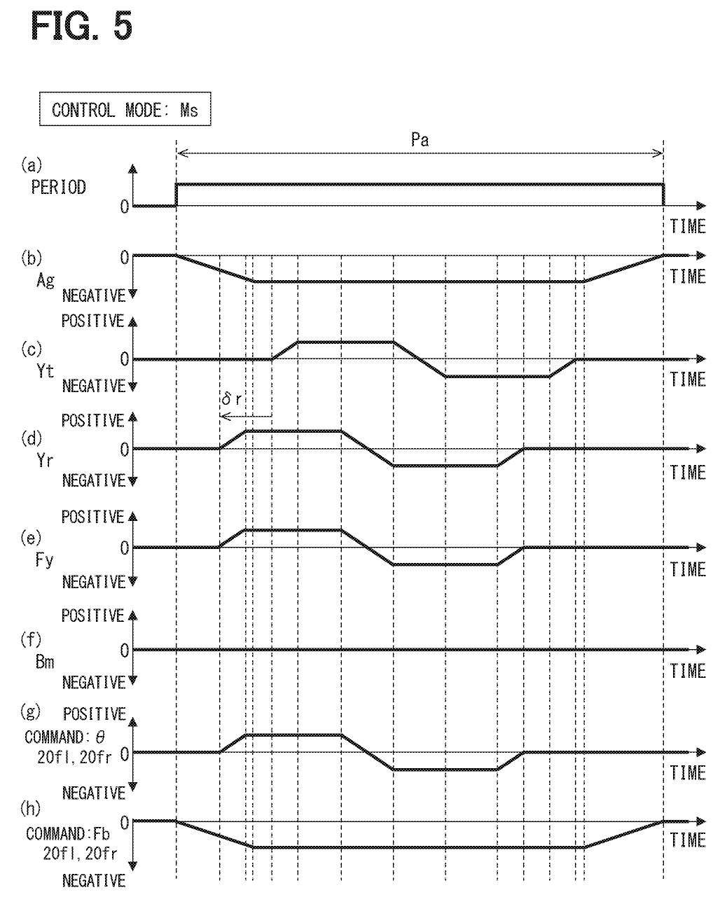

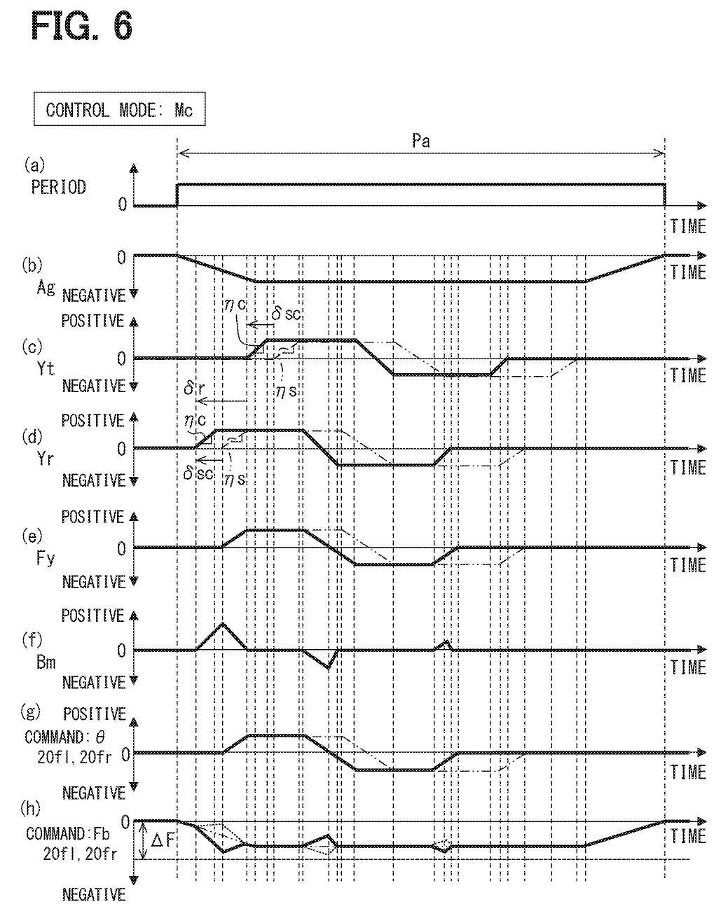

As shown in FIG. 2, front wheels 20fl, 20fr and rear wheels 20rl, 20rr are provided as a plurality of wheels 20 of the host vehicle 2. Therefore, the braking actuator 44 independently adjusts respective braking forces Fb for the front wheels 20fl, 20fr and respective braking forces Fb for the rear wheels 20rl, 20rr as braking forces (see FIG. 5 and FIG. 6 described later) applied to the host vehicle 2. With this, in the host vehicle 2, the left-right distribution and front-rear distribution of the braking force Fb are controllable.

The steering actuator 42 adjusts at least one of a steering angle θ common to the front wheels 20fl, 20fr and a steering angle θ common to the rear wheels 20rl, 20rr as steering angles (see FIG. 5 and FIG. 6 described later) applied to the host vehicle 2. The common steering angle θ of the front wheels 20fl, 20fr and the common steering angle θ of the rear wheels 20rl, 20rr may be adjusted independently of each other, and in the host vehicle 2 in this case, the front-rear distribution between these common steering angles θ is controllable.

As shown in FIG. 1, the sensor system 5 acquires sensing information usable in the driving assistance system 1 by sensing the external environment and internal environment of the host vehicle 2. For that purpose, the sensor system 5 includes external sensors 50 and internal sensors 52.

The external sensors 50 sense objects 3 present in the outside world of the host vehicle 2. The object sensing type external sensor 50 is at least one type among, for example, image sensors (i.e., vehicle-mounted cameras), LiDAR (light detection and ranging / laser imaging detection and ranging), laser sensors, millimeter-wave sensors, sonar sensors, and the like. The object sensing type external sensors 50 are preferably implemented by combining a plurality of types so as to be capable of sensing in each direction of the front, sides, and rear of the host vehicle 2.

The internal sensors 52 sense specific kinematic physical quantities related to vehicle motion in the interior of the host vehicle 2. The motion sensing type internal sensor 52 is at least one type among, for example, a speed sensor, an acceleration sensor, a gyro sensor, and the like. The internal sensor 52 may sense operations or states of occupants including the driver as occupants boarding the interior of the host vehicle 2. The occupant sensing type internal sensor 52 is at least one type among, for example, an accelerator pedal sensor, a steering angle sensor, a steering torque sensor, a brake pedal sensor, a shift sensor, an occupant camera, steering switches, a biological sensor, a seating sensor, in-vehicle device switches, and the like.

The communication system 6 acquires communication information usable in the driving assistance system 1 via wireless communication. The communication system 6 may receive positioning signals from artificial satellites of a GNSS (global navigation satellite system) existing in the outside world of the host vehicle 2. The positioning type communication system 6 is, for example, a GNSS receiver or the like. The communication system 6 may transmit and receive communication signals to and from a V2X (Vehicle-to-Everything) system existing in the outside world of the host vehicle 2. The V2X communication type communication system 6 is at least one type among, for example, a DSRC (dedicated short range communications) communication device, a cellular V2X (C-V2X) communication device, and the like. The communication system 6 may transmit and receive communication signals to and from a mobile terminal existing in the interior of the host vehicle 2. The terminal communication type communication system 6 is at least one type among, for example, Bluetooth (registered trademark) devices, Wi-Fi (registered trademark) devices, infrared communication devices, and the like.

The map DB 7 stores map information usable in the driving assistance system 1. The map DB 7 is configured including at least one type of non-transitory tangible storage medium among, for example, semiconductor memory, magnetic media, optical media, and the like. The map DB 7 may be a DB of a locator that estimates the self-position of the host vehicle 2. The map DB 7 may be a DB of a navigation unit that navigates a travel route of the host vehicle 2. The map DB 7 may be constructed by a combination of a plurality of types of DBs.

The map DB 7 acquires and stores the latest map information through, for example, V2X communication with an external center via the communication system 6. The map information is converted into data in two dimensions or three dimensions as information representing the external environment where the host vehicle 2 travels. As three-dimensional map information, digital data of a high-definition map may be adopted. The map information includes road information representing at least one type among, for example, positions, shapes, and road surface conditions of road structures. The map information may include structure information representing at least one type among positions and shapes of buildings and traffic lights facing the road, for example. The map information may include marking information representing at least one type among positions and shapes of signs and lane markings attached to the road, for example.

The information presentation system 8 presents notification information toward occupants including the driver of the host vehicle 2. The information presentation system 8 presents notification information by stimulating the vision of the occupants in the host vehicle 2. The visual information presentation type information presentation system 8 is at least one type among, for example, a vehicle-mounted monitor, a HUD (head-up display), a combination meter, a navigation unit, an illumination unit, and the like. The information presentation system 8 may present notification information by stimulating the hearing of the occupants. The auditory information presentation type information presentation system 8 is at least one type among, for example, a speaker, a buzzer, a vibration unit, and the like. The information presentation system 8 may present notification information by stimulating the cutaneous sensation of the occupants. The cutaneous sensation information presentation type information presentation system 8 is at least one type among, for example, a vibration unit, a reaction force unit, an air conditioning unit, and the like.

The driving assistance system 1 is connected to the actuator system 4, the sensor system 5, the communication system 6, the map DB 7, and the information presentation system 8 via at least one type among, for example, a LAN (local area network), a wire harness, an internal bus, a wireless communication line, and the like. The driving assistance system 1 is configured including at least one dedicated computer.

The dedicated computer constituting the driving assistance system 1 may be an integration ECU (electronic control unit) that integrates driving control of the host vehicle 2. The dedicated computer constituting the driving assistance system 1 may be a sensing ECU that processes sensing information in the driving control of the host vehicle 2. The dedicated computer constituting the driving assistance system 1 may be a recognition ECU that recognizes the outside world in the driving control of the host vehicle 2. The dedicated computer constituting the driving assistance system 1 may be a locator ECU that estimates the self-position of the host vehicle 2.

The dedicated computer constituting the driving assistance system 1 may be a planning ECU that plans the driving control of the host vehicle 2. The dedicated computer constituting the driving assistance system 1 may be a navigation ECU that navigates a travel route in the driving control of the host vehicle 2. The dedicated computer constituting the driving assistance system 1 may be an actuator ECU that controls the actuator system 4 as driving control of the host vehicle 2.

The dedicated computer constituting the driving assistance system 1 may be an information management ECU that controls the information presentation system 8 as driving control of the host vehicle 2. The dedicated computer constituting the driving assistance system 1 may be at least one external computer, such as an external center or a mobile terminal capable of communication via the communication system 6.

The dedicated computer constituting the driving assistance system 1 has at least one memory 10 and at least one processor 12. The memory 10 is at least one type of non-transitory tangible storage medium that non-temporarily stores programs and data readable by the computer, among, for example, semiconductor memory, magnetic media, optical media, and the like. The processor 12 includes at least one type as a core among, for example, a CPU (central processing unit), a GPU (graphics processing unit), a RISC (reduced instruction set computer)-CPU, and the like.

The processor 12 executes a plurality of instructions included in a driving assistance program stored in the memory 10 as software. Thereby, the driving assistance system 1 constructs a plurality of functional blocks for performing driving assistance processing of the host vehicle 2. The plurality of functional blocks thus constructed by the driving assistance system 1 include an operation determination block 100, a trajectory generation block 120, and a driving control block 140 shown in FIG. 3.

The operation determination block 100 acquires sensing information from the sensor system 5. The operation determination block 100 generates operation data by determining a manual driving operation of the driver with respect to the host vehicle 2 based on the acquired sensing information. The operation data regarding the manual driving operation may represent at least one type of operation parameter corresponding to the driver's operation among, for example, an accelerator pedal operation amount, a steering operation angle, a steering operation torque, a brake pedal operation amount, a shift operation position, and the like.

The trajectory generation block 120 acquires sensing information from the sensor system 5. The trajectory generation block 120 acquires communication information from the communication system 6. The trajectory generation block 120 acquires map information from the map DB 7. The trajectory generation block 120 acquires data of control commands to the host vehicle 2 in the past from the driving control block 140. The trajectory generation block 120 generates recognition data recognizing the external environment and internal environment of the host vehicle 2 by individually processing and then fusing these acquired information and data. The recognition data generated by the trajectory generation block 120 in this way represents the states of the external environment and internal environment recognized for each driving scene in which the host vehicle 2 travels.

Specifically, the trajectory generation block 120 preferably generates recognition data by localization that recognizes the self-state of the host vehicle 2. The recognition data regarding the self-state may represent at least one type of kinematic physical quantity among, for example, position, velocity, acceleration, jerk (rate of change of acceleration), yaw rate, yaw angle, etc., appearing in the host vehicle 2 according to control commands in the driving control block 140 described in detail later. The trajectory generation block 120 preferably generates recognition data by recognizing objects 3 in the outside world of the host vehicle 2. The recognition data regarding the object 3 may represent at least one type of kinematic physical quantity among, for example, separation distance, direction of movement, relative velocity, relative acceleration, time to collision (TTC) with the host vehicle 2, and the like.

The trajectory generation block 120 plans a driving trajectory Td (see FIG. 2) targeted in the future travel of the host vehicle 2 based on the generated recognition data. The driving trajectory Td defines a time-series change for each control cycle assumed in the future ahead of the present, regarding motion parameters targeted as the self-state of the host vehicle 2. Specifically, the driving trajectory Td preferably represents position coordinates for each control cycle of a trajectory that the host vehicle 2 is made to follow in the future. Further, the driving trajectory Td preferably represents at least one type of kinematic physical quantity among, for example, velocity, acceleration, jerk (rate of change of acceleration), yaw rate, yaw angle, etc., as motion parameters to be made to appear for each control cycle on such a trajectory.

The driving control block 140 acquires operation data from the operation determination block 100. The driving control block 140 acquires data of the driving trajectory Td together with the recognition data from the trajectory generation block 120. The driving control block 140 acquires data of control commands to the host vehicle 2 in the past by reading from the memory 10. Based on these acquired data, the driving control block 140 generates control commands for controlling the driving behavior of the host vehicle 2. At this time, a control command commanded to the actuator system 4 is generated so as to control a driving task corresponding to an automated driving level adjusted according to the driving scene, among the automated driving task and the manual driving assistance task in the host vehicle 2. The control command generated in this way is stored in the memory 10.

Examples of the driving task corresponding to the automated driving level include adaptive cruise control (ACC), autonomous emergency braking (AEB), lane keeping assist (LKA), and the like. Therefore, the adjustment of the automated driving level preferably includes a handover in which the driving task is transferred between the driving assistance system 1 and the driver by transition of the driving mode between the automated driving task and the manual driving assistance task. Such a handover is realized at least at one type of timing among, for example, a transfer request timing from the driver, an entry/exit timing with respect to an operational design domain (ODD) of automated driving, a necessary timing for a minimum risk maneuver (MRM), and the like.

### Driving Assistance Flow

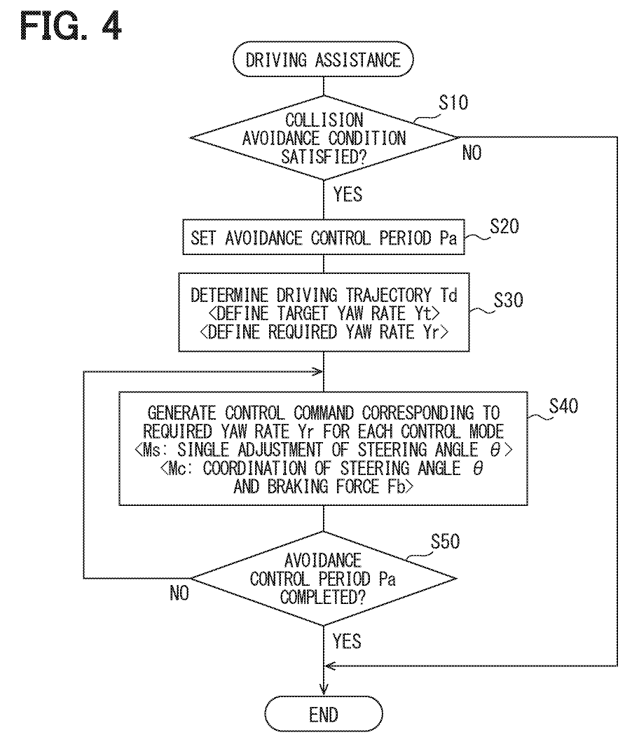

In the first embodiment, a driving assistance flow realizing a driving assistance method for assisting driving of the host vehicle 2 is repeatedly executed according to FIG. 4 by the cooperation of the plurality of blocks 100, 120, 140. In the following description, each "S" in the driving assistance flow means a plurality of steps executed by a plurality of instructions included in the driving assistance program, respectively.

In S10 shown in FIG. 4, the trajectory generation block 120 determines whether or not a collision avoidance condition requiring collision avoidance with an object 3 in the future travel of the host vehicle 2 is satisfied. The collision avoidance condition is satisfied when the collision risk between the host vehicle 2 and the object 3 rises to a collision avoidance range requiring collision avoidance for the host vehicle 2. Therefore, the arrival of the collision risk at the collision avoidance range is determined based on the recognition data generated by the trajectory generation block 120. At this time, the collision risk may be determined to have arrived at the collision avoidance range when the TTC becomes equal to or less than a threshold time (e.g., 2 seconds, etc.). In addition to such requirements of TTC, the collision risk may be determined to have arrived at the collision avoidance range when, for example, a required probability of collision avoidance by lane change or the like becomes equal to or greater than a threshold value.

In S10, when a negative determination is made due to the non-satisfaction of the collision avoidance condition, the current driving assistance flow ends. On the other hand, when a positive determination is made in S10 due to the satisfaction of the collision avoidance condition, the current driving assistance flow proceeds to S20. In S20, the trajectory generation block 120 sets an avoidance control period Pa for performing emergency control of the host vehicle 2 toward collision avoidance.

In the subsequent S30, the trajectory generation block 120 determines a driving trajectory Td that serves as a tracing target of the host vehicle 2 over the avoidance control period Pa, toward collision avoidance with the object 3 in the future travel of the host vehicle 2. At this time, the driving trajectory Td is planned so as to define a time-series change of a target yaw rate Yt shown in FIG. 5 and FIG. 6 for each control cycle, in addition to a trajectory that is a time-series change of position coordinates, as motion parameters targeted in the future travel of the host vehicle 2. The sign of the target yaw rate Yt in FIG. 5 and FIG. 6 is defined such that the counterclockwise direction is positive and the clockwise direction is negative around the yaw axis in the host vehicle 2 in a top view, but naturally, a definition of the reverse relationship may be used.

In defining the target yaw rate Yt for planning such a driving trajectory Td, a time-series change of a target lateral acceleration may be defined for each control cycle as a motion parameter targeted in the future travel of the host vehicle 2. Also, as a motion parameter targeted in the future travel of the host vehicle 2, a target longitudinal acceleration Ag shown in FIG. 5 and FIG. 6 may be defined for each control cycle, so that the driving trajectory Td including the target longitudinal acceleration Ag is planned. The sign of the target longitudinal acceleration Ag in FIG. 5 and FIG. 6 is defined such that the backward direction of the host vehicle 2 is negative, but naturally, it may be defined as a positive sign.

Specifically, the trajectory generation block 120 in the trajectory planning of S30 first estimates response characteristics assumed for the host vehicle 2 in the avoidance control period Pa. At this time, as the response characteristics, a ground load on each of at least the front wheels 20fl, 20fr among the wheels 20 may be estimated. As the response characteristics, a maximum yaw moment generatable in the host vehicle 2 may be estimated.

Next, the trajectory generation block 120 in the trajectory planning of S30 selects a control mode so as to match the response characteristics of the host vehicle 2 estimated in the avoidance control period Pa. As shown in FIG. 5 and FIG. 6, the control modes include a single control mode Ms of the steering angle θ, and a coordinated control mode Mc of the steering angle θ and the braking force Fb. The sign of the steering angle θ in FIG. 5 and FIG. 6 is defined such that the counterclockwise direction is positive and the clockwise direction is negative around the yaw axis relative to the front-rear axis in the host vehicle 2 in a top view, but naturally, a definition of the reverse relationship may be used. Also, the sign of the braking force Fb in FIG. 5 and FIG. 6 is defined such that the backward direction of the host vehicle 2 is negative, but naturally, it may be defined as a positive sign.

The single control mode Ms shown in FIG. 5 (see also the two-dot chain line graph in FIG. 6) is one control mode of turning posture control (i.e., so-called yawing control) that controls the turning posture of the host vehicle 2 by independently adjusting the steering angle θ of at least the front wheels 20fl, 20fr among the wheels 20 in the avoidance control period Pa. On the other hand, the coordinated control mode Mc shown in FIG. 6 is another control mode of turning posture control that controls the turning posture of the host vehicle 2 by coordinating the steering angle θ and the braking force Fb of at least the front wheels 20fl, 20fr among the wheels 20 in the avoidance control period Pa. Particularly in this coordinated control mode Mc, regarding at least the front wheels 20fl, 20fr among the wheels 20, the left-right distribution of the braking force Fb is coordinated with the left-right common steering angle θ, whereby the turning posture of the host vehicle 2 in the avoidance control period Pa is optimally controlled toward collision avoidance.

In the mode selection of S30, for response characteristics that are positively estimated to allow left-right distribution of the braking force Fb of at least the front wheels 20fl, 20fr among the wheels 20 in the avoidance control period Pa within a limit range ΔF as shown in FIG. 6, the coordinated control mode Mc matching them is selected. In other words, for response characteristics that are negatively estimated regarding the left-right distribution within the limit range ΔF for the braking force Fb of at least the front wheels 20fl, 20fr among the wheels 20 in the avoidance control period Pa, the single control mode Ms matching them is selected.

Therefore, in the mode selection of S30, the feasibility of the left-right distribution may be determined according to the ground load estimated as the response characteristics. In the mode selection of S30, the feasibility of the left-right distribution may be determined according to the maximum yaw moment estimated as the response characteristics. In the mode selection of S30, the feasibility of the left-right distribution may be determined in consideration of limit values for longitudinal acceleration and/or longitudinal jerk (rate of change of acceleration) in the host vehicle 2.

Further, the trajectory generation block 120 in the trajectory planning of S30 sets the target yaw rate Yt shown in FIG. 5 and FIG. 6 among the motion parameters of the driving trajectory Td for each selected control mode. At this time, in the coordinated control mode Mc shown by the solid line graph in FIG. 6, the phase of the target yaw rate Yt is adjusted to the advance side compared to the single control mode Ms shown by the two-dot chain line graph in the same FIGURE(see also FIG. 5). Along with this, in the coordinated control mode Mc shown by the solid line graph in FIG. 6, the absolute value of the differential value serving as the gradient in the time change period of the target yaw rate Yt, that is, the magnitude of yaw angular acceleration ηc equivalent to the gradient, is increased and adjusted compared to the magnitude of yaw angular acceleration ηs in the single control mode Ms shown by the two-dot chain line graph (see also FIG. 5) in the same figure.

These phase advance adjustment and increase adjustment rely on the fact that the response speed of the actual yaw rate to the control command in the host vehicle 2 becomes higher in the case of coordination of the steering angle θ and the braking force Fb than in the case of single adjustment of the steering angle θ. Therefore, the phase lead time δsc by the phase advance adjustment and the increase adjustment ratio between the magnitudes of the yaw angular accelerations ηs and ηc are set according to, for example, a minimum speed difference among response speed differences between actual yaw rates estimated based on response characteristics in each of the coordinated control mode Mc and the single control mode Ms. At this time, for example, at least one type among the ground load and maximum yaw moment estimated as response characteristics, and limit values of longitudinal acceleration and/or longitudinal jerk, etc., may be reflected in the setting of the lead time δsc and the increase adjustment ratio.

In addition to the trajectory planning, in S30 shown in FIG. 4, the trajectory generation block 120 defines a required yaw rate Yr required for the host vehicle 2 for each control cycle of the avoidance control period Pa by further correcting the set target yaw rate Yt. At this time, as shown in FIG. 5 and FIG. 6, the phase of the required yaw rate Yr is adjusted to the advance side compared to the phase of the target yaw rate Yt according to the planned driving trajectory Td in either of the control modes Ms and Mc. A phase lead time δr by such phase advance adjustment is commonly used between the control modes Ms and Mc, and is set to, for example, a maximum delay time among response delay times predicted for the actuator system 4. The sign of the required yaw rate Yr in FIG. 5 and FIG. 6 is defined such that the counterclockwise direction is positive and the clockwise direction is negative around the yaw axis in the host vehicle 2 in a top view, but naturally, a definition of the reverse relationship may be used.

According to S30 described in detail so far, in the coordinated control mode Mc shown by the solid line graph in FIG. 6, the phase of the required yaw rate Yr conforming to the target yaw rate Yt is advanced by the lead time δsc compared to the single control mode Ms shown by the two-dot chain line graph in the same FIGURE(see also FIG. 5). Along with this, according to S30, in the coordinated control mode Mc shown by the solid line graph in FIG. 6, the magnitude of the yaw angular acceleration ηc, which is the gradient in the time change period of the required yaw rate Yr conforming to the target yaw rate Yt, is increased and adjusted compared to the magnitude of the yaw angular acceleration ηs in the single control mode Ms shown by the two-dot chain line graph in the same FIGURE(see also FIG. 5).

As a result of such S30, the driving trajectory Td is determined so as to define the required yaw rate Yr for controlling the turning posture of the host vehicle 2 in the avoidance control period Pa by the single adjustment of the steering angle θ in the single control mode Ms. On the other hand, as a result of S30, the driving trajectory Td is determined so as to define the required yaw rate Yr for controlling the turning posture of the host vehicle 2 in the avoidance control period Pa by the coordination of the steering angle θ and the braking force Fb in the coordinated control mode Mc.

In S40 shown in FIG. 4, the driving control block 140 generates control commands to the actuator system 4 to control the steering angle θ and the braking force Fb, respectively, according to the driving trajectory Td for which data was acquired from the trajectory generation block 120 after execution of S20 and S30. At this time, in particular, control commands for each of the steering actuator 42 and the braking actuator 44 are generated in correspondence with the required yaw rate Yr for each control mode selected in S30, among the motion parameters defined by the driving trajectory Td. Although description is omitted below, in the first embodiment, when the host vehicle 2 is in an override state by the driver due to a manual driving operation, the control command may be corrected based on operation data from the operation determination block 100.

Specifically, in generating the control command in the single control mode Ms, as shown in FIG. 5, a braking yaw moment Bm made to appear in the host vehicle 2 by the single adjustment of the braking force Fb is set to a 0 value. Therefore, the control command of the single control mode Ms is generated as shown in FIG. 5 (see also the two-dot chain line graph of FIG. 6) so as to control the braking force Fb of at least the front wheels 20fl, 20fr among the wheels 20 to a substantially common value on the left and right, i.e., a left-right distribution command value of substantially 1:1, according to the target longitudinal acceleration Ag and the braking yaw moment Bm. The sign of the braking yaw moment Bm in FIG. 5 and FIG. 6 is defined such that the counterclockwise direction is positive and the clockwise direction is negative around the yaw axis in the host vehicle 2 in a top view, but naturally, a definition of the reverse relationship may be used.

At the same time, the control command of the single control mode Ms is generated so as to control only the steering angle θ of at least the front wheels 20fl, 20fr among the wheels 20 to an angle command value according to the required yaw rate Yr. At this time, the angle command value of the steering angle θ is preferably adjusted so as to satisfy a lateral force control value Fy made to follow the change of the required yaw rate Yr as shown in FIG. 5 (see also the two-dot chain line graph of FIG. 6). The sign of the lateral force control value Fy in FIG. 5 and FIG. 6 is defined such that the left direction is positive and the right direction is negative with respect to the front-rear axis in the host vehicle 2 in a top view, but naturally, a definition of the reverse relationship may be used.

On the other hand, in generating the control command in the coordinated control mode Mc, as shown in FIG. 6, the braking yaw moment Bm corresponding to the amount made to appear in the host vehicle 2 only by the braking force Fb is set in accordance with the advance of the required yaw rate Yr. Therefore, the control command of the coordinated control mode Mc is generated as shown by the solid line graph and the dashed line graph of FIG. 6 so as to control the braking force Fb of at least the front wheels 20fl, 20fr among the wheels 20 to a left-right distribution command value that simultaneously satisfies the target longitudinal acceleration Ag and the braking yaw moment Bm. The solid line graph in FIG. 6 shows the braking force Fb of the left front wheel 20fl, and the dashed line graph in FIG. 6 shows the braking force Fb of the right front wheel 20fr.

At the same time, the control command of the coordinated control mode Mc is generated so as to control the steering angle θ of at least the front wheels 20fl, 20fr among the wheels 20 to an angle command value that satisfies the required yaw rate Yr by coordination with the left-right distribution command value of the braking force Fb. At this time, the angle command value of the steering angle θ is preferably adjusted so as to satisfy the lateral force control value Fy correlated by canceling out a change due to the appearance of the braking yaw moment Bm with respect to the change of the required yaw rate Yr as shown by the solid line graph of FIG. 6.

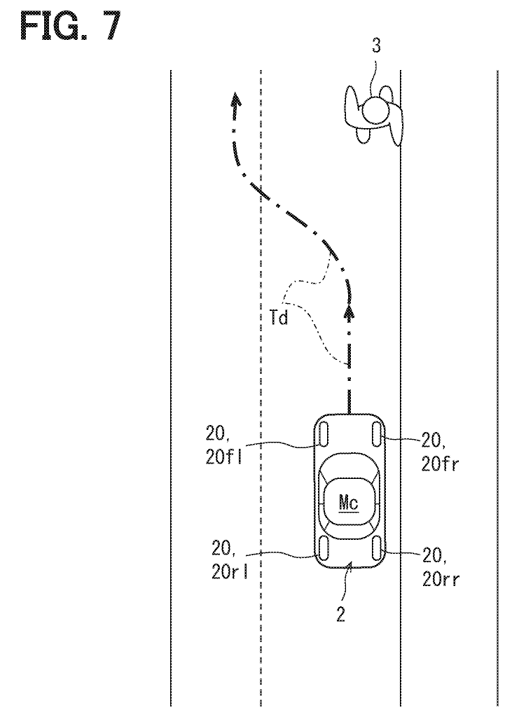

As shown in FIG. 4, in S50 following S40, the driving control block 140 determines whether or not the avoidance control period Pa in the current driving assistance flow has been completed. As a result, when a negative determination is made during the avoidance control period Pa, S40 is repeated, whereby the next control cycle in the current driving assistance flow is started. On the other hand, when a positive determination is made due to the completion of the avoidance control period Pa, the current driving assistance flow ends. According to the driving assistance flow, in the coordinated control mode Mc illustrated in FIG. 7, collision avoidance with the object 3 in a shorter time becomes possible during the avoidance control period Pa as compared with the single control mode Ms illustrated in FIG. 2.

### Operation and Effects

The operation and effects of the first embodiment will be explained below.

In the first embodiment, during the avoidance control period Pa for controlling the host vehicle 2 toward collision avoidance with the object 3, the steering angle θ and the braking force Fb applied to the wheels 20 in the host vehicle 2 are respectively controlled according to the driving trajectory Td of the host vehicle 2. Therefore, in the avoidance control period Pa of the first embodiment, the driving trajectory Td of the host vehicle 2 is determined so as to define the required yaw rate Yr.

Specifically, in the determination of the driving trajectory Td according to the first embodiment, a control mode that matches the response characteristics estimated for the host vehicle 2 in the avoidance control period Pa is selected. As a result, in a driving environment where the turning posture of the host vehicle 2 toward collision avoidance can be controlled even by the single adjustment of the steering angle θ, the single control mode Ms matching the estimated response characteristics in the avoidance control period Pa is selected, and the required yaw rate Yr for the turning posture control by the single adjustment can be reflected in the driving trajectory Td. On the other hand, in a driving environment where control of the turning posture toward collision avoidance is required in a short time by the coordination of the steering angle θ and the braking force Fb, the coordinated control mode Mc matching the estimated response characteristics in the avoidance control period Pa is selected, and the required yaw rate Yr for the turning posture control by the coordination can be reflected in the driving trajectory Td. According to the above configuration, it becomes possible to provide driving assistance to the host vehicle 2 according to a driving trajectory Td that is effective regardless of the driving environment in collision avoidance with the object 3.

In the coordinated control mode Mc according to the first embodiment, the required yaw rate Yr is defined for controlling the turning posture of the host vehicle 2 by coordinating the left-right distribution of the braking force Fb with the steering angle θ. According to this, even in a driving environment where short-time control of the turning posture is required toward collision avoidance, the driving trajectory Td defining the required yaw rate Yr by coordinating the left-right distribution of the braking force Fb with the steering angle θ by selection of the coordinated control mode Mc matching the estimated response characteristics in the avoidance control period Pa can be adapted to the driving environment. Therefore, it becomes possible to provide driving assistance to the host vehicle 2 according to the driving trajectory Td effective regardless of the driving environment in collision avoidance with the object 3.

According to the first embodiment, for response characteristics that are positively estimated to allow left-right distribution of the braking force Fb within the limit range ΔF in the avoidance control period Pa, the coordinated control mode Mc matching them is selected. According to this, in a driving environment where short-time control of the turning posture is required toward collision avoidance, stability of the host vehicle 2 when tracing the driving trajectory Td defining the required yaw rate Yr by coordinating the left-right distribution of the braking force Fb within the limit range ΔF with the steering angle θ by selection of the coordinated control mode Mc matching the possible response characteristics can be secured. Therefore, it is possible to increase reliability in providing driving assistance to the host vehicle 2 according to the driving trajectory Td effective regardless of the driving environment in collision avoidance with the object 3.

According to the first embodiment, the phase of the required yaw rate Yr in the coordinated control mode Mc is adjusted to be advanced compared to that in the single control mode Ms. According to this, even in a driving environment where short-time control of the turning posture is required toward collision avoidance, in the coordinated control mode Mc matching the estimated response characteristics where a high response speed to the actual yaw rate is expected by the coordination of the braking force Fb and the steering angle θ in the avoidance control period Pa, the required yaw rate Yr whose phase is adjusted to be advanced can be reflected in the driving trajectory Td. Therefore, it is possible to increase reliability in providing driving assistance to the host vehicle 2 according to the driving trajectory Td effective regardless of the driving environment in collision avoidance with the object 3.

According to the first embodiment, the magnitude of the yaw angular acceleration ηc which is the gradient of the required yaw rate Yr in the coordinated control mode Mc is adjusted to be increased compared to the magnitude of the yaw angular acceleration ηs in the single control mode Ms. According to this, even in a driving environment where short-time control of the turning posture is required toward collision avoidance, in the coordinated control mode Mc matching the estimated response characteristics where a high response speed to the actual yaw rate is expected by the coordination of the braking force Fb and the steering angle θ in the avoidance control period Pa, the required yaw rate Yr whose gradient is adjusted to be increased can be reflected in the driving trajectory Td. Therefore, it is possible to increase reliability in providing driving assistance to the host vehicle 2 according to the driving trajectory Td effective regardless of the driving environment in collision avoidance with the object 3.

### Second Embodiment

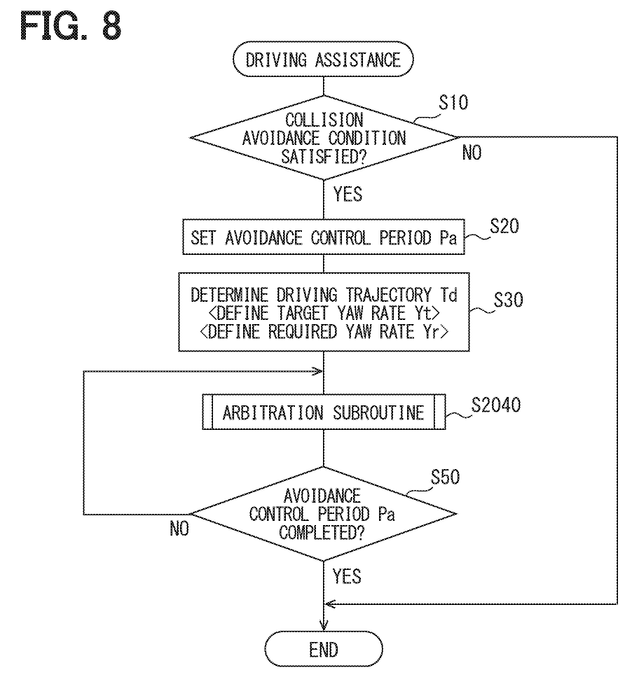

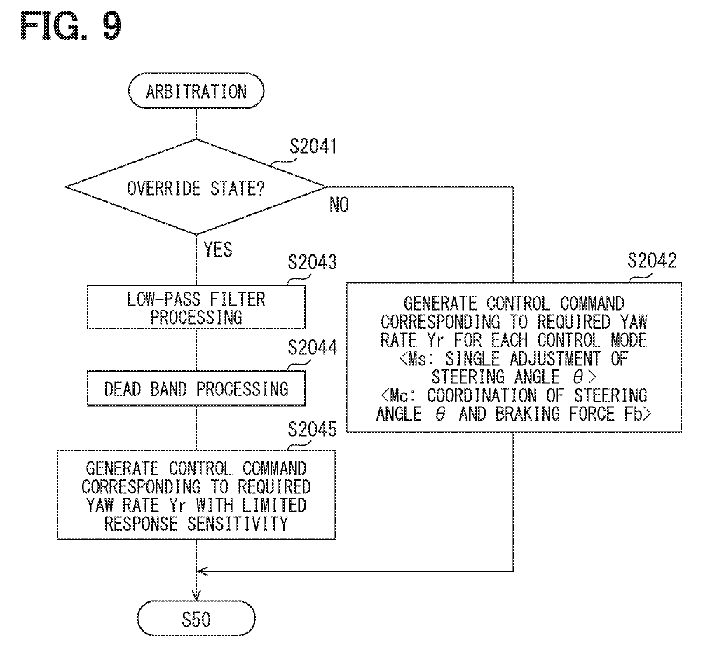

A second embodiment is a modification of the first embodiment. As shown in FIG. 8 and FIG. 9, in a driving assistance flow of the second embodiment, S2041 to S2045 of an arbitration subroutine are executed in S2040, which replaces S40 of the first embodiment. This arbitration subroutine is added so as to define the required yaw rate Yr by limiting the response sensitivity for a steering operation that is in an override state in the host vehicle 2.

Specifically, in S2041 of the arbitration subroutine shown in FIG. 9, the trajectory generation block 120 determines whether or not the host vehicle 2 is in an override state where it is overridden by a manual driving operation of the driver, based on the operation data from the operation determination block 100. As a result, when a negative determination is made in the host vehicle 2 during the automated driving task due to a non-override state of the driver, the arbitration subroutine proceeds to S2042. In S2042, the driving control block 140 generates control commands to the actuator system 4 (however, excluding correction in the override state) in accordance with S40 of the first embodiment. The arbitration subroutine proceeds to S50 in response to the completion of execution of S2042.

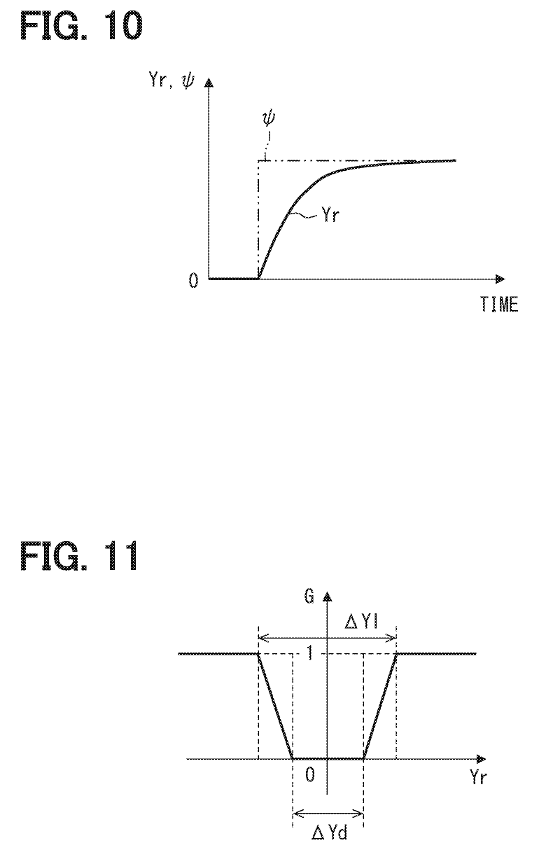

On the other hand, when a positive determination is made in S2041, the arbitration subroutine proceeds to S2043. In S2043, the trajectory generation block 120 performs low-pass filter processing as shown in FIG. 10. Specifically, the low-pass filter processing of S2043 raises the attenuation rate of a frequency component as the frequency component of a steering operation angle ψ by the driver is higher, passing it as the required yaw rate Yr.

Due to such low-pass filter processing of FIG. 10 by S2043, even if the steering operation angle ψ changes suddenly (see the two-dot chain line graph in the same figure), the required yaw rate Yr is defined so as to change over time more gently (see the solid line graph in the same figure) than the steering operation angle ψ. That is, the response sensitivity of the required yaw rate Yr to the steering operation angle ψ is subject to a first stage limitation by the low-pass filter processing.

In the subsequent S2044 of the arbitration subroutine shown in FIG. 9, the trajectory generation block 120 performs dead band processing as shown in FIG. 11. Specifically, in the dead band processing of S2044, when an absolute value which is the magnitude of the required yaw rate Yr after the low-pass filter processing falls within a dead band ΔYd, a correction gain G for the absolute value is forced to a minimum gain (here, 0 times). On the other hand, in the dead band processing, when the absolute value of the required yaw rate Yr after the low-pass filter processing falls outside the dead band ΔYd within a limit range ΔYl, the correction gain G is gradually changed to increase from the minimum gain to a maximum gain (here, 1 time) as the absolute value increases. Further, in the dead band processing, when the absolute value of the required yaw rate Yr after the low-pass filter processing falls outside the limit range ΔYl, the correction gain G for the absolute value is fixed to the maximum gain. In the dead band processing, the correction gain G may be adjusted based on yaw angular acceleration which is a differential value of the required yaw rate Yr, instead of the absolute value of the required yaw rate Yr.

According to such dead band processing of FIG. 11 by S2044, the required yaw rate Yr is defined such that the output value of the required yaw rate Yr after the low-pass filter processing is corrected to be reduced by the correction gain G while its magnitude is small. That is, the response sensitivity of the required yaw rate Yr to the steering operation is subject to a second stage limitation by the dead band processing.

The driving trajectory Td in the override state by the driver is determined so as to define the required yaw rate Yr that has undergone the low-pass filter processing and the dead band processing. At this time, among motion parameters of the driving trajectory Td, motion parameters other than the required yaw rate Yr may be defined as planned values according to S30 or values obtained by correcting the planned values based on the required yaw rate Yr that has undergone the low-pass filter processing and the dead band processing.

In further subsequent S2045 of the arbitration subroutine shown in FIG. 9, the driving control block 140 generates control commands to the actuator system 4 to control the steering angle θ and the braking force Fb, respectively, according to the driving trajectory Td for which data was acquired from the trajectory generation block 120 after execution of S2043 and S2044. At this time, in particular, control commands for each of the steering actuator 42 and the braking actuator 44 are generated in correspondence with the required yaw rate Yr for which the response sensitivity to the steering operation of the driver is limited, among the motion parameters defined by the driving trajectory Td. The arbitration subroutine proceeds to S50 in response to the completion of execution of S2045. It can be said that the arbitration subroutine arbitrates the driving control in the override state according to S2045 against the driving control in the non-override state according to S2042.

### Operation and Effects

The operation and effects peculiar to the second embodiment will be explained below.

According to the second embodiment, the driving trajectory Td is determined so as to define the required yaw rate Yr by limiting the response sensitivity to the steering operation of the driver who is in the override state in the host vehicle 2. According to this, in the override state where the driver's steering operation is likely to fluctuate, the required yaw rate Yr can be reflected in the driving trajectory Td by a definition in which the response sensitivity to the fluctuation is limited, so that it becomes possible to increase the robustness of the driving control.

### Other Embodiments

Although a plurality of embodiments have been described, the present disclosure is not to be interpreted as being limited to those embodiments, and can be applied to various embodiments and combinations within a range not departing from the gist of the present disclosure.

In a modification, the dedicated computer constituting the driving assistance system 1 may have at least one of a digital circuit and an analog circuit as a processor. Here, the digital circuit is at least one type among, for example, an ASIC (Application Specific Integrated Circuit), an FPGA (Field Programmable Gate Array), an SOC (System on a Chip), a PGA (Programmable Gate Array), a CPLD (Complex Programmable Logic Device), and the like. Such a digital circuit may have a memory storing a program.

In a modification, the operator who manually drives the host vehicle 2 to which the driving assistance system 1 is applied may be a remote operator who remotely operates the driving of the host vehicle 2 from an external center. In a modification, the driving assistance system 1 may be configured to be realizable only for the automated driving task without the existence of the manual driving assistance task for assisting the manual driving operation of the operator.

In S30 of a modification, regarding the required yaw rate Yr in the coordinated control mode Mc, only one of the phase advance adjustment and the increase adjustment between the magnitudes of the yaw angular accelerations ηs and ηc which serve as gradients may be performed. In S30 of a modification, as a condition of response characteristics matching the selected control mode, in addition to the limit range ΔF of the braking force Fb, at least one type among restrictions on operation of the actuator system 4 according to temperature etc., feasibility of coordinated operation of respective actuators 40, 42, 44 in the actuator system 4, road surface conditions, etc., may be considered.

In the coordinated control mode Mc of a modification, the actual yaw moment according to the braking yaw moment Bm may be generated also by the rear wheels 20rl, 20rr in S40 and S2042 by specifying the required yaw rate Yr in S30 with the steering angles of the front wheels 20fl, 20fr and the steering angles of the rear wheels 20rl, 20rr among the wheels 20 as coordination targets.

What is claimed is:

1. A driving assistance system comprising:
a processor,
wherein
the driving assistance system is configured to assist in a collision avoidance between a host vehicle and an object during operation of the host vehicle,
the processor is configured to:
determine a driving trajectory of the host vehicle during an avoidance control period in which the host vehicle is controlled for the collision avoidance; and
respectively control a steering angle and a braking force applied to wheels of the host vehicle according to the driving trajectory,
the determination of the driving trajectory includes:
selecting, from among a single control mode in which a turning posture of the host vehicle during the avoidance control period is controlled by a single adjustment of the steering angle and a coordinated control mode in which the turning posture during the avoidance control period is controlled by a coordination of the steering angle and the braking force, a control mode that matches a response characteristic estimated for the host vehicle during the avoidance control period;
determining, in the single control mode, the driving trajectory so as to specify a required yaw rate necessary to control the turning posture by the single adjustment of the steering angle;
determining, in the coordinated control mode, the driving trajectory so as to specify the required yaw rate necessary to control the turning posture by the coordination of the steering angle and the braking force; and
specifying, in the coordinated control mode, the required yaw rate necessary to control the turning posture by coordinating a left-right distribution of the braking force with the steering angle.

2. The driving assistance system according to claim 1, wherein
determining the driving trajectory includes selecting the coordinated control mode that matches the response characteristic estimated for the host vehicle during the avoidance control period, in which the left-right distribution of the braking force within a limitation range is positively estimated.

3. The driving assistance system according to claim 1, wherein
determining the driving trajectory includes, in the coordinated control mode, adjusting a phase of the required yaw rate so as to be advanced relative to a phase of the required yaw rate in the single control mode.

4. The driving assistance system according to claim 1, wherein
determining the driving trajectory includes, in the coordinated control mode, increasing magnitude of a yaw angle acceleration, which is a gradient of the required yaw rate, relative to magnitude of a yaw angle acceleration in the single control mode.

5. The driving assistance system according to claim 1, wherein
determining the driving trajectory includes determining the driving trajectory so as to specify the required yaw rate by limiting a response sensitivity to a steering operation by a driver who is in an override state of the host vehicle.

6. A non-transitory computer readable storage medium storing a driving assistance program stored in a storage medium for assisting a collision avoidance between a host vehicle and an object during operation of the host vehicle, the driving assistance program comprising instructions for causing a processor to:
determine a driving trajectory of the host vehicle during an avoidance control period in which the host vehicle is controlled for the collision avoidance; and
respectively control a steering angle and a braking force applied to wheels of the host vehicle according to the driving trajectory,
wherein
the determination of the driving trajectory includes:
selecting, from among a single control mode in which a turning posture of the host vehicle during the avoidance control period is controlled by a single adjustment of the steering angle, and a coordinated control mode in which the turning posture during the avoidance control period is controlled by a coordination of the steering angle and the braking force, a control mode that matches a response characteristic estimated for the host vehicle during the avoidance control period;
determining, in the single control mode, the driving trajectory so as to specify a required yaw rate necessary to control the turning posture by the single adjustment of the steering angle;
determining, in the coordinated control mode, the driving trajectory so as to specify the required yaw rate necessary to control the turning posture by the coordination of the steering angle and the braking force; and
specifying, in the coordinated control mode, the required yaw rate necessary to control the turning posture by coordinating a left-right distribution of the braking force with the steering angle.

7. A driving assistance method executed by a processor for assisting a collision avoidance between a host vehicle and an object during operation of the host vehicle, the driving assistance method comprising:
determining a driving trajectory of the host vehicle during an avoidance control period in which the host vehicle is controlled for the collision avoidance; and
respectively controlling a steering angle and a braking force applied to wheels of the host vehicle according to the driving trajectory,
wherein the determination of the driving trajectory includes:
selecting, from among a single control mode in which a turning posture of the host vehicle during the avoidance control period is controlled by a single adjustment of the steering angle, and a coordinated control mode in which the turning posture during the avoidance control period is controlled by a coordination of the steering angle and the braking force, a control mode that matches a response characteristic estimated for the host vehicle during the avoidance control period;
determining, in the single control mode, the driving trajectory so as to specify a required yaw rate necessary to control the turning posture by the single adjustment of the steering angle;
determining, in the coordinated control mode, the driving trajectory so as to specify the required yaw rate necessary to control the turning posture by the coordination of the steering angle and the braking force; and
specifying, in the coordinated control mode, the required yaw rate necessary to control the turning posture by coordinating a left-right distribution of the braking force with the steering angle.

8. A driving assistance system comprising:
a processor,
wherein
the driving assistance system is configured to assist in a collision avoidance between a host vehicle and an object during operation of the host vehicle,
the processor is configured to:
determine a driving trajectory of the host vehicle during an avoidance control period in which the host vehicle is controlled for the collision avoidance; and
respectively control a steering angle and a braking force applied to wheels of the host vehicle according to the driving trajectory,
the determination of the driving trajectory includes:
selecting, from among a single control mode in which a turning posture of the host vehicle during the avoidance control period is controlled by a single adjustment of the steering angle and a coordinated control mode in which the turning posture during the avoidance control period is controlled by a coordination of the steering angle and the braking force, a control mode that matches a response characteristic estimated for the host vehicle during the avoidance control period;
determining, in the single control mode, the driving trajectory so as to specify a required yaw rate necessary to control the turning posture by the single adjustment of the steering angle;
determining, in the coordinated control mode, the driving trajectory so as to specify the required yaw rate necessary to control the turning posture by the coordination of the steering angle and the braking force; and
adjusting, in the coordinated control mode, a phase of the required yaw rate so as to be advanced relative to a phase of the required yaw rate in the single control mode.

9. A driving assistance system comprising:
a processor,
wherein
the driving assistance system is configured to assist in a collision avoidance between a host vehicle and an object during operation of the host vehicle,
the processor is configured to:
determine a driving trajectory of the host vehicle during an avoidance control period in which the host vehicle is controlled for the collision avoidance; and
respectively control a steering angle and a braking force applied to wheels of the host vehicle according to the driving trajectory,
the determination of the driving trajectory includes:
selecting, from among a single control mode in which a turning posture of the host vehicle during the avoidance control period is controlled by a single adjustment of the steering angle and a coordinated control mode in which the turning posture during the avoidance control period is controlled by a coordination of the steering angle and the braking force, a control mode that matches a response characteristic estimated for the host vehicle during the avoidance control period;
determining, in the single control mode, the driving trajectory so as to specify a required yaw rate necessary to control the turning posture by the single adjustment of the steering angle;
determining, in the coordinated control mode, the driving trajectory so as to specify the required yaw rate necessary to control the turning posture by the coordination of the steering angle and the braking force; and
increasing, in the coordinated control mode, magnitude of a yaw angle acceleration, which is a gradient of the required yaw rate, relative to magnitude of a yaw angle acceleration in the single control mode.
